(19) United States
(12) Patent Application Publication
(10) Pub. No.: US 2010/0258612 A1
(43) Pub. Date: Oct. 14, 2010

(54) FRICTION STIR WELDING TOOL

(75) Inventors: Christian Kolbeck, Kapfenberg (AT); Reinhard Pitonak, Bruck an der Mur (AT); Ronald Weissenbacher, Bruck an der Mur (AT)

Correspondence Address: GREENBLUM & BERNSTEIN, P.L.C., 1950 ROLAND CLARKE PLACE, RESTON, VA, 20191, US

(73) Assignee: BOEHLERIT GMBH & CO.KG., Kapfenberg (AT)

(21) Appl. No.: 12/742,760

(22) PCT Filed: Oct. 31, 2008
(86) PCT No.: PCT/AT08/00395

§ 371 Date: May 13, 2010

(30) Foreign Application Priority Data
Nov. 16, 2007 (AT) A 1862/2007

(51) Int. Cl. B23K 20/12

(52) U.S. Cl. 228/2.1

(57) ABSTRACT

The invention relates to a friction stir welding tool (1) with an essentially cylindrical shank (2), which has a peg (3) with a smaller diameter projecting on one end (5) starting from a shoulder region (4) of the shank (2). According to the invention it is provided in order to create a friction stir welding tool (1) for welding steel, that the friction stir welding tool (1), at least in the region of the peg (3) and in the shoulder region (4), is made of a hard metal containing 80% by weight to 98% by weight tungsten carbide with an average grain size of more than 1 μm and up to 20% by weight cobalt as well as optionally a total of up to 18% by weight titanium carbide, tantalum carbide, niobium carbide and/or mixed carbides thereof and at least in one of the referenced regions has a coating of one or more layers.

### CROSS-REFERENCE TO RELATED APPLICATIONS

The present application is a U.S. National Stage of International Patent Application No. PCT/AT2008/000395 filed Oct. 31, 2008, and claims priority under 35 U.S.C. §119 and 365 of Austrian Patent Application No. A 1862/2007 filed Nov. 16, 2007. Moreover, the disclosure of International Patent Application No. PCT/AT2008/000395 is expressly incorporated by reference herein in its entirety.

### BACKGROUND OF THE INVENTION

1. Field of the Invention

The invention relates to a friction stir welding tool with an essentially cylindrical shank, which has a pin with a smaller diameter projecting on one end starting from a shoulder region of the shank.

2. Discussion of Background Information

Friction stir welding is a welding process known for approximately two decades, in which a tool of the type mentioned at the outset is placed with the pin-side end against workpieces to be joined and is set in rotation. Through the rotation of the pin and the adjacent shoulder region or the frictional heat produced thereby, the materials of the workpieces to be joined are heated and rendered paste-like. As soon as the materials of the workpieces to be joined are sufficiently paste-like, the pin ensures a thorough intermixing of the materials of the workpieces to be joined in the connection area. When the workpieces are allowed to cool in the region of the engagement zone of the pin, a welding point is formed that is improved compared to conventional welding processes, which in particular can be free of pores and/or undesirable structural formations.

Although still a recent technological development, friction stir welding is already used in many fields of application, primarily for welding workpieces of low-melting materials, for example, aluminum alloys.

Recently attempts have also been made to make the advantages achieved with a friction stir welding productive in the welding of higher-melting materials, for example, steel. However, one problem has been so far that the friction stir welding tools used often warp at the high welding temperatures. Furthermore, a detachment or breaking-off of the pin or pins from the shank can occur during the welding process or the shank itself can break.

### SUMMARY OF THE INVENTION

The invention discloses an improved friction stir welding tool for welding steel.

The invention is directed to a friction stir welding tool of the type mentioned at the outset when the friction stir welding tool, at least in the region of the pin and in the shoulder region, is made of a hard metal containing 80% by weight to 98% by weight tungsten carbide with an average grain size of more than 1 μm and up to 20% by weight cobalt as well as optionally a total of up to 18% by weight titanium carbide, tantalum carbide, niobium carbide and/or mixed carbides thereof and at least in one of the referenced regions has a coating of one or more layers, wherein in particular at least one layer is made preferably chiefly of aluminum titanium nitride or aluminum chromium nitride.

The advantages achieved with the invention are to be seen in particular in that, based on the provided weight percentage of tungsten carbide and cobalt, respectively, the friction stir welding tool has a substrate that on the one hand is less susceptible with respect to breaks, but on the other hand is also not so soft that deformations of the tool would occur during application or use. In connection therewith a provided average grain size of the tungsten carbide in the sintered tool blank of more than 1 μm also appears to be essential. As tests have shown, smaller average grain sizes do not lead to the desired result, which is interesting. It is assumed that the necessary thermal conductivity of the shank is too low with a finer grain. Compared to known solutions on a tungsten/rhenium basis, another advantage is to be seen in that with a friction stir welding tool according to the invention a tendency to stick of the materials to be welded, for example steel, was not observed or was observed only to a reduced extent.

In connection with the hard, but nevertheless tough substrate, the provided coating guarantees a long service life of the friction stir welding tool in the welding of steel. In this respect it is assumed that the provided layers, for example, of aluminum titanium nitride or aluminum chromium nitride, above all in the region of the shoulder edge serve as heat barriers and in particular in the adjoining shoulder region as a wear protection and thus combat an undesirable heating and deformation of the friction stir welding tool as well as wear. In order to keep fracture susceptibility low with high hardness and at the same time to avoid a deformation of the friction stir welding tool during use as far as possible, expediently it can be provided that the hard metal contains 2% by weight to 15% by weight cobalt.

Moreover, it is favorable if the hard metal is composed of tungsten carbide and 2% by weight to 12% by weight, preferably 3% by weight to 9% by weight, cobalt, namely for the above-referenced reasons. It is particularly favorable to restrict the cobalt content to a maximum of 9% by weight, since at temperatures of more than 1000° C., cobalt through diffusion into the coating can contribute to the destruction thereof, which is promoted by higher cobalt contents. A minimum content of cobalt is necessary for the desired toughness, wherein in the context an exclusion of further carbides (apart from contaminants due to production) such as titanium carbide and/or tantalum carbide and/or niobium carbide as well as mixed carbides is recommended, since these can have an embrittling effect.

It is particularly preferred with respect to a service life of the tool when an average grain size of the tungsten carbide is as large as possible and is more than 2 μm, preferably more than 2.5 μm, in particular 2.5 μm to 8.5 μm.

CVD processes as well as PVD processes can be used to produce the provided coating. It has proven to be useful to produce the coating by means of a PVD process. The reason for this is that a partial coating of the friction stir welding tool is not possible with conventional coating devices with a CVD process. However, a partial coating can be carried out with a PVD process, in particular only in the region of the pin, in the shoulder region as well as over a length of approx. 10 mm in that region of the shank that adjoins the shoulder region. This partial coating is desirable in that basically the shank should be able to release heat well and is to be provided with a coating or coating layer serving as a heat barrier and wear protection only in that region in which it is exposed to highest temperatures, that is, in the region of the pin, the shoulder and the region of the shank adjoining it.

Preferably, as coatings those are used of or with at least one layer that contains chiefly aluminum titanium nitride or aluminum chromium nitride. With a layer of this type a proportion of aluminum nitride is greater than a proportion of titanium nitride or chromium nitride. Depending on the type of layer, it can have further phases.

In order to guarantee the necessary heat resistance and wear resistance, the coating is embodied with a layer thickness of the layer containing chiefly aluminum titanium nitride or aluminum chromium nitride of 0.5 μm to 8 μm.

Nanostructured coatings with at least one layer of aluminum titanium nitride and silicon nitride or aluminum chromium nitride and silicon nitride have proven to be particularly preferred among the coatings. Coatings of this type are known per se and can have a poriferous network of α-Si₃N₄ with a wall thickness of the network of less than 2 nanometers. Aluminum titanium nitride and/or aluminum chromium nitride with a grain size of less than 20 nanometers is distributed in the pores.

It is particularly preferred with respect to a long service life of the friction stir welding tool if the outermost layer of the coating is a layer that contains chiefly aluminum titanium nitride or aluminum chromium nitride.

The geometric embodiment of the friction stir welding tool can be carried out in a similar manner to the prior art, wherein it has been shown that a particularly long service life can be achieved if the pin is embodied essentially in a cylindrical manner. The pin is thereby expediently arranged on an axis of the shank.

### BRIEF DESCRIPTION OF THE DRAWINGS

Further features, advantages and effects of the invention are shown by the exemplary embodiments shown below and the drawings, to which reference is made. They show:

FIG. 1 A friction stir welding tool with an essentially cylindrical shank;

FIG. 2 An enlarged representation of the section along the line of cut II-II in FIG. 1;

FIG. 3 A part of the shank of the friction stir welding tool according to FIG. 1;

FIG. 4 A friction stir welding tool with a non-cylindrical pin;

FIG. 5 An enlarged representation of the section along the line of cut V-V in FIG. 4;

FIG. 6 An enlarged representation of a plan view of a friction stir welding tool according to FIG. 4;

FIG. 7 An enlarged representation of the section along the line of cut VII-VII in FIG. 6.

### DETAILED DESCRIPTION OF THE PRESENT INVENTION

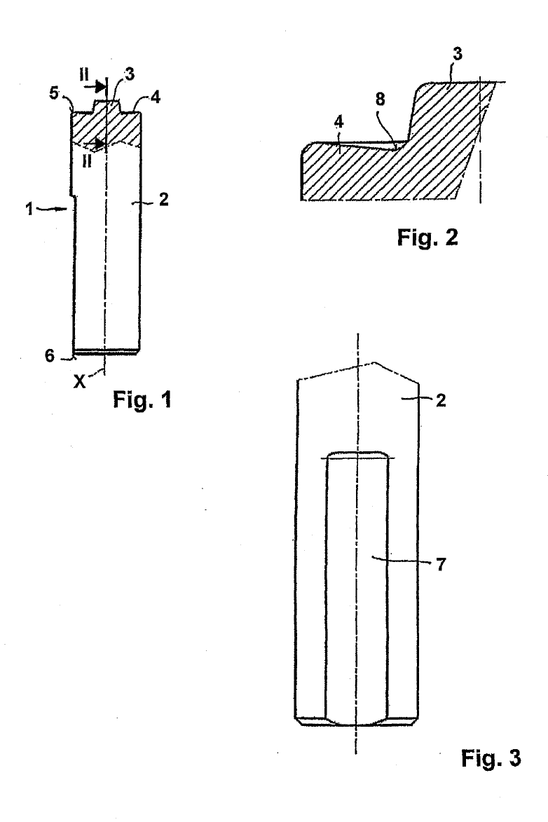

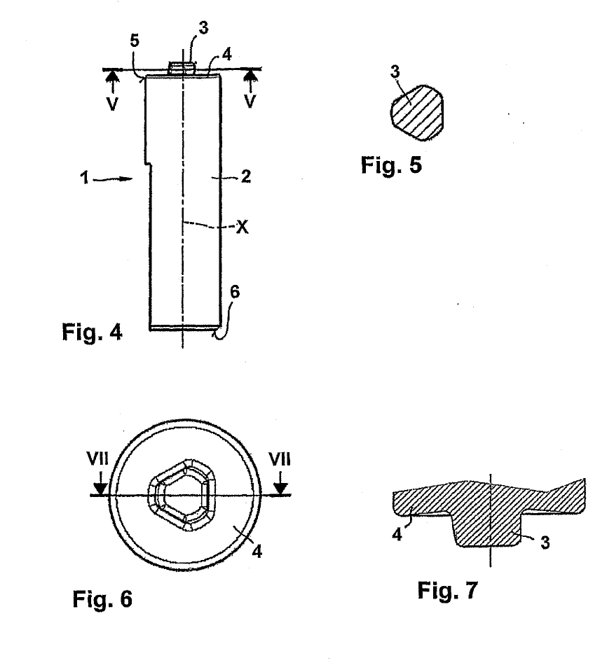

FIG. 1 through FIG. 3 as well as FIG. 4 through FIG. 7 show two friction stir welding tools 1, as they can be used within the scope of the invention. Each friction stir welding tool 1 has an approximately cylindrical shank 2 with two ends 5, 6. The first end 5 is respectively embodied with a shoulder region 4 running from the edge or a shoulder edge to the axis X of the shank 2 initially at an angle declining from up to 15°, which shoulder region then ascending merges respectively into a projecting pin 3 or pin arranged on the central axis X of the shank 2. The transition 8 from the shoulder region 4 to the pin 3 can thereby be embodied in a rounded manner, as can be seen from FIG. 2. Seen from the center of the shank 2 in the direction of the axis X, the pin 3 is embodied slightly tapering in a conical manner at an angle of approximately 5° to 15°, preferably 7° to 12°. Furthermore, a guide groove 7 can be provided on the shank 2 starting from the second end 6, in order to render possible an attachment and secure holding of the friction stir welding tool 1 in a device.

The friction stir welding tools 1 shown in FIG. 1 through FIG. 3 or FIG. 4 through FIG. 7 can respectively be made as a whole from a hard metal, which is coated at least in the region of the pin 3, in the shoulder region 4 as well as in the lateral region of the shank 2 adjoining the shoulder region 4 (up to approximately 10 mm). The friction stir welding tools 1 however can also be embodied in a two-part manner, wherein a first part, which comprises the pin 3, the shoulder region 4 as well as a first region of the shank 2 with a length of approximately 10 mm, is made of hard metal and a second part, which comprises the rest of the shank 2 up to its second end 6, is made of steel. A connection of the two parts can be carried out, for example, by screwing or closure by adhesive force.

Friction stir welding tools 1, as shown in FIG. 1 through FIG. 3, were produced from different hard metals on a tungsten carbide basis. The compositions, Vickers hardnesses HV30, the average grain sizes of the tungsten carbide powder used in the production of the tools by sintering, that is, the so-called Fisher grain sizes, as well as the densities of the hard metals are given in the following Table 1. Compared to the Fisher grain sizes, the grain sizes obtained after a sintering are much smaller and for example with an average Fisher grain size of 9.5 μm, are in the range of 2.5 μm to 3.0 μm.

TABLE 1

| | Composition (in | | | | | | |
|---|---|---|---|---|---|---|---|
| Sub- | percentage by weight) | | | | | Grain size | Density |
| strate | WC | Co | TiC | Ta(Nb)C | HV30 | WC (μm) | (g/cm³) |
| A | 57.5 | 9.5 | 18.0 | 15.0 | 1575 | 2.5 | 10.30 |
| B | 92.0 | 8.0 | | | 1275 | 9.5 | 14.75 |
| C | 90.0 | 10.0 | | | 1675 | 0.8 | 14.40 |
| D | 87.0 | 13.0 | | | 1150 | 9.5 | 14.20 |
| E | 77.0 | 11.0 | 4.0 | 8.0 | 1400 | 5.3 | 13.15 |
| F | 73.7 | 26.0 | 0.2 | 0.2 | 838 | 9.5 | 13.10 |

For a coating of the friction stir welding tools 1 according to Table 1, the types of coating listed in the following Table 2 were used. Thereby single-layer coatings (coatings no. 1 and no. 9) as well as multi-layer coatings (for example, coating no. 4) were used. A thickness of the individual layers in the case of multi-layer coatings as well as the sequence of the individual layers can be seen from Table 2.

TABLE 2

| | | |
|---|---|---|
| Coating | Composition | Total layer thickness (μm) |

| No. 1 | AlTiSiN | (3.0 μm) | 3.0 |
|---|---|---|---|
| No. 2 | TiCN* | (7.5 μm) | 8.0 |
| | TiN | (0.5 μm) | |
| | Substrate | | |
| No. 3 | TiN/AlCrN | (3.0 μm) | 3.0 |
| No. 4 | TiAlN | (2.0 μm) | 5.0 |
| | TiN/TiAlN | (3.0 μm) | |
| | Substrate | | |
| No. 5 | Al₂O₃ | (0.5 μm) | 16.0 |
| | TiN | (0.5 μm) | |
| | TiCN | (1.5 μm) | |
| | Al₂O₃ | (4.0 μm) | |
| | TiCN* | (7.0 μm) | |
| | TiCN | (2.0 μm) | |
| | TiN | (0.5 μm) | |
| | Substrate | | |
| No. 6 | Al₂O₃ | (7.0 μm) | 19.0 |
| | TiCN* | (8.0 μm) | |
| | TiCN | (3.0 μm) | |
| | TiN | (1.0 μm) | |
| | Substrate | | |
| No. 7 | AlCrN | (2.0 μm) | 7.0 |
| | TiAlN | (2.0 μm) | |
| | TiN/TiAlN | (3.0 μm) | |
| | Substrate | | |
| No. 8 | AlCrN | (2.0 μm) | 10.0 |
| | TiCN* | (7.5 μm) | |
| | TiN | (0.5 μm) | |
| | Substrate | | |
| No. 9 | AlTiN | (6.0 μm) | 6.0 |

*produced according to WO 2007/056785 A1

In a first series of tests, different friction stir welding tools 1 were coated with compositions or properties according to Table 1 in the region of the pin 3, the shoulder region 4 and, starting from the shoulder region 4 or one end 5, over a length of approx. 10 mm on the shank 2, wherein individual coatings with individual substrates A, B and C were combined to form a test matrix. The friction stir welding tools 1 thus produced were subsequently used for welding workpieces of steel, wherein a weld seam length was 20 mm. Following the welding, the individual friction stir welding tools 1 were tested by optical and metallurgical means.

Table 3 gives a summary of the results of the test matrix. As can be seen from this table, with friction stir welding tools 1 with a substrate A, a fracture of the shank 2 occurred in three cases. If no coating was provided, starting from the shoulder region 4 longitudinal cracks occurred in the shank 2. For friction stir welding tools 1 of a substrate C in the case without coating or a coating no. 1, only a spot weld could be carried out, since a massive deformation of the shoulder edge occurred. For the variants in which a substrate C was combined with a coating no. 2, no. 3 or no. 4, with a weld seam length of 20 mm a massive wear of the pin 3 and/or a deformation of the shoulder region 4 or of the shoulder edge of the shank 2 or a breaking off of the pin 3 (pin fracture) was ascertained. In contrast, friction stir welding tools 1 of a substrate B coated with a coating no. 2, no. 5, no. 6, no. 7 or no. 8, were essentially intact even after the welding operation, i.e., it was not possible to detect either a major deformation or a wear or an abrasion of the pin 3 or pin.

TABLE 3

| | Coating | | | | | | | | |
|---|---|---|---|---|---|---|---|---|---|
| Substrate | None | No. 1 | No. 2 | No. 3 | No. 4 | No. 5 | No. 6 | No. 7 | No. 8 |
| A | Longitudinal | Shank | Shank | | | Shank | | | |
| | cracks | fracture | fracture | | | fracture | | | |
| B | Intact, slight | | Intact | | | Intact, | Intact | Intact | Intact |
| | deformation | | | | | slight | | | |
| | | | | | | wear | | | |
| C | Deformation* | Deformation* | Wear, | Pin | Wear, | | | | |
| | | | deformation | fracture | deformation | | | | |

*only spot welding

In a further series of tests, in addition to substrate B further substrates D, E and F were in turn combined with different coatings. Corresponding friction stir welding tools 1 were used to connect steel parts to one another over a weld seam length of 150 mm. The friction stir welding tools 1 were tested as in the first test series by optical and metallurgical means. The results are shown in Table 4 below.

TABLE 4

| | Coating | | | |
|---|---|---|---|---|
| Substrate | No. 1 | No. 9 | No. 7 | No. 2 |
| B | Intact | Intact | Intact | Pin fracture |
| | | | | (at approx. 85 mm) |
| D | Intact | Pin fracture | Pin fracture | Pin fracture |
| | | (at approx. 85 mm) | (at approx. 145 mm) | (at approx. 25 mm) |
| E | Deformation, | Deformation, | Intact | Pin fracture |
| | wear | wear | | (at approx. 48 mm) |
| F | Deformation, | Deformation, | Deformation, | |
| | fracture at 20 mm | fracture at 20 mm | fracture at 20 mm | |

As can be seen from the tables, it is expedient in order to be able to produce weld seams of great length that on the one hand the substrate is produced essentially from approx. 2% by weight to 15% by weight cobalt and on the other hand tungsten carbide with a grain size of preferably more than 2.0 μm (in the sintered state), and in particular a heat-resistant and wear-resistant coating with at least one layer containing AlTiN, AlCrN or doped variants thereof, e.g., AlTiSiN, is provided, that is, layers in which a proportion of aluminum nitride exceeds a proportion of titanium nitride or chromium nitride (in contrast, e.g., to TiAlN). Thus, for the combinations of the coatings no. 1, no. 9 and no. 7 with the substrates B and D it was established that with a weld seam length of 150 mm, friction stir welding tools 1 on the basis of one of the substrates B and D respectively with a coating no. 1 are intact. However, with the combination of the same substrates with the coatings no. 7 or no. 9, in the case of substrate D a pin fracture occurred at 145 mm or 85 mm respectively. Based on the last observation, it is assumed that the cobalt content of substrate B, which is reduced compared to substrates B and D, has a favorable effect.

In a further series of tests, friction stir welding tools 1 of the substrate B were provided with up to 10 μm thick nanostructured PVD coatings of aluminum chromium nitride and silicon nitride and tested compared to commercial tools on a tungsten/rhenium basis. While tools of substrate B with the referenced coatings during welding of steel sheets with a thickness of respectively 4 mm with a total weld length of 550 mm exhibited hardly any appearance of wear and no sticking or hardly any sticking could be observed, clear signs of wear as well as sticking could be established on the commercial tools. With reference to the weld seams, an excellent quality could be determined with the use of tools according to the invention.

1. Friction stir welding tool (1) with an essentially cylindrical shank (2), which has a peg (3) with a smaller diameter projecting on one end (5) starting from a shoulder region (4) of the shank (2), characterized in that the friction stir welding tool (1), at least in the region of the peg (3) and in the shoulder region (4), is made of a hard metal containing 80% by weight to 98% by weight tungsten carbide with an average grain size of more than 1 μm and up to 20% by weight cobalt as well as optionally a total of up to 18% by weight titanium carbide, tantalum carbide, niobium carbide and/or mixed carbides thereof and at least in one of the referenced regions has a coating of one or more layers.

2. Friction stir welding tool (1) according to claim 1, characterized in that the hard metal contains 2% by weight to 15% by weight cobalt.

3. Friction stir welding tool (1) according to claim 1, characterized in that the hard metal is composed of tungsten carbide and 2% by weight to 12% by weight, preferably 3% by weight to 9% by weight, cobalt.

4. Friction stir welding tool (1) according to claim 1, characterized in that the average grain size of the tungsten carbide is more than 2 μm, preferably more than 2.5 μm, in particular 2.5 μm to 8.5 μm.

5. Friction stir welding tool (1) according to claim 1, characterized in that the coating is a PVD coating.

6. Friction stir welding tool (1) according to claim 1, characterized in that the coating has at least one layer that contains chiefly aluminum titanium nitride or aluminum chromium nitride.

7. Friction stir welding tool (1) according to claim 6, characterized in that a layer thickness of the layer containing chiefly aluminum titanium nitride or aluminum chromium nitride is 0.5 μm to 8 μm.

8. Friction stir welding tool (1) according to claim 6, characterized in that the layer is a nanostructured layer of aluminum titanium nitride and silicon nitride or aluminum chromium nitride and silicon nitride.

9. Friction stir welding tool (1) according to claim 1, characterized in that the outermost layer of the coating is a layer that contains chiefly aluminum titanium nitride or aluminum chromium nitride.

10. Friction stir welding tool (1) according to claim 1, characterized in that the peg (3) is embodied essentially in a cylindrical manner.

11. Friction stir welding tool (1) according to claim 1, characterized in that the peg (3) is arranged on an axis (X) of the shank (2).
